(19) United States
(12) Patent Application Publication
(10) Pub. No.: US 2014/0043173 A1
(43) Pub. Date: Feb. 13, 2014

(54) STREETLIGHT, SERVER AND SYSTEM FOR CALLING FOR TAXIS

(71) Applicants: TE-SHENG CHEN, Miaoli (TW); XIAO-GUANG LI, Shenzhen (CN); KUAN-HONG HSIEH, New Taipei (TW); YUN XIAO, Shenzhen (CN); SHANG-HUI PI, Shenzhen (CN); SHUANG RUI, Shenzhen (CN)

(72) Inventors: TE-SHENG CHEN, Miaoli (TW); XIAO-GUANG LI, Shenzhen (CN); KUAN-HONG HSIEH, New Taipei (TW); YUN XIAO, Shenzhen (CN); SHANG-HUI PI, Shenzhen (CN); SHUANG RUI, Shenzhen (CN)

(21) Appl. No.: 13/729,058

(22) Filed: Dec. 28, 2012

(30) Foreign Application Priority Data
Aug. 13, 2012 (CN) 2012102860747

(51) Int. Cl. G08G 1/13

(52) U.S. Cl. CPC G08G 1/13
USPC 340/990; 340/993

(57) ABSTRACT

A streetlight includes a storage unit pre-storing a location of the streetlight, a communicating unit communicating with a server, an input unit mounted facing toward an outside of the streetlight, a display unit, and a control unit. The input unit generates a first request signal in response to a user operation thereon. The control unit obtains the location of the streetlight stored in the storage unit in response to the first request signal, generates a second request signal carrying the obtained location, and controls the communicating unit to transmit the second request signal to the server. The server schedules one or more taxis which are currently vacant and whose current locations are near the obtained location. The display unit displays the one or more current locations and one or more identifications of the one or more taxi scheduled. A related server and system are also provided.

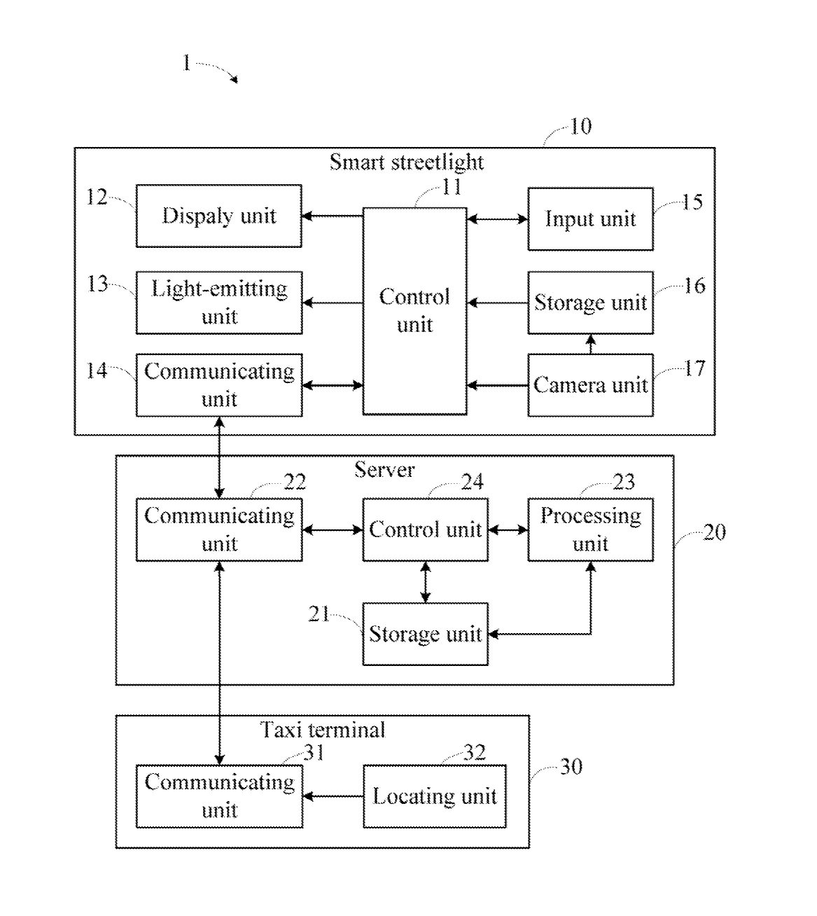

### BACKGROUND

1. Technical Field

The present disclosure relates to traffic monitoring systems and, particularly, to a streetlight, a server and a system for calling for taxis.

2. Description of the Related Art

Vacant taxis often cruise from here to there looking for passengers, and this may waste time and energy. People needing a taxi may wait and wait at the curbside till a vacant taxi arrives, and this is inconvenient and time consuming What is needed is a means for improving these situations.

### BRIEF DESCRIPTION OF THE DRAWING

The emphasis is placed upon clearly illustrating the principles of the disclosure.

The drawing is a diagram block of a system for calling for taxis, according to an exemplary embodiment.

### DETAILED DESCRIPTION

The drawing shows a system 1 for calling for taxis. The system 1 includes a plurality of streetlights 10, a server 20, and a plurality of taxi terminals 30. The plurality of streetlights 10 communicate with the server 20 via a wired network or a wireless network, such as Power Line Communication (PLC), Optical Power Line Communication (OPLC), Zigbee, Wireless Fidelity (WiFi), 3G wireless technology, 4G wireless technology, General Packet Radio Service (GPRS), Code-Division Multiple Access (CDMA), Global System for Mobile communications (GSM), or satellite communication (SATCOM), for example. The plurality of taxi terminals 30 communicates with the server 20 via a wireless network, such as 3G wireless technology, 4G wireless technology, GPRS, CDMA, GSM, or SATCOM, for example. Each of the plurality of taxi terminals 30 is employed in a taxi (not shown).

Each taxi terminal 30 includes a communicating unit 31 and a locating unit 32. In the embodiment, the locating unit 32 is a Global Positioning System (GPS). The locating unit 32 is configured for regularly detecting a current location of the taxi terminal 30 after every predetermined time interval has elapsed. The communicating unit 31 is configured for transmitting an identification of the taxi having the taxi terminal 30, the current location of the taxi detected by the locating unit 32, and a state of the taxi to the server 20. The state of the taxi may be an engaged state, a vacant state, or an off-duty state. The engaged state means the taxi has one or more passengers onboard, the vacant state means the taxi is looking for a passenger, and the off-duty state means the taxi is not available for passengers at that time. In this description, unless the context indicates otherwise, a “passenger” also includes a person looking for a taxi to board.

The server 20 includes a storage unit 21, a communicating unit 22, a processing unit 23, and a control unit 24. The storage unit 21 is configured for pre-storing a table recording a plurality of identifications of the taxi terminals 30 registered in the server 20, and information on the taxis employing the taxi terminals 30. The information on the taxis includes the locations and the states of the taxis. In the embodiment, the identification of a taxi terminal 30 includes a license number of the taxi in which the taxi terminal 30 is employed. In an alternative embodiment, the identification of the taxi terminal 30 includes a name of an owner of the taxi in which the taxi terminal 30 is employed. The communicating unit 22 is configured for communicating with the plurality of streetlights 10 to get the locations of passengers who are looking for taxis, and communicating with the plurality of taxi terminals 30 to get the locations and states of the taxis. When the server 20 gets the location and the state of a taxi via the communicating unit 22, the control unit 24 updates the information under the identification of the taxi terminal 30 employed in the taxi.

Each streetlight 10 includes a control unit 11, a display unit 12, a light-emitting unit 13, a communicating unit 14, an input unit 15, and a storage unit 16. The light-emitting unit 13 is mounted to face toward an outside of the streetlight 10 for illuminating (typically a part of) a thoroughfare such as a street. The communicating unit 14 is configured for communicating with the server 20. The input unit 15 is also mounted to face toward an outside of the streetlight 10, for facilitating user operation of the input unit 15. The input unit 15 generates a first request signal in response to a user's operations thereof. In the embodiment, the input unit 15 is a mechanical button. In an alternative embodiment, the input unit 15 is a keyboard. The storage unit 16 is configured for pre-storing a location of the streetlight 10. The control unit 11 is configured for obtaining the location stored in the storage unit 16 in response to the first request signal, generating a second request signal carrying the obtained location, and further controlling the communicating unit 14 to transmit the second request signal to the server 20.

When the server 20 receives the second request signal transmitted by the streetlight 10, the processing unit 23 determines the taxi terminals 30 corresponding to the taxis which are currently vacant according to the information stored in the table, and further determines the taxi terminals 30 of the currently vacant taxis whose current locations are near the location taken out from the second request signal. The control unit 24 is configured for generating a scheduling signal carrying the location taken out from the second request signal, and the identifications and the locations of the currently vacant taxis which are near the location taken out from the second request signal. The control unit 24 is further configured for controlling the communicating unit 22 to transmit the scheduling signal to the corresponding taxi terminals 30 and the streetlight 10 which transmitted the first request signal. Each taxi terminal 30 receives and parses the scheduling signal, and shows a driver of the taxi the location of the streetlight 10 which transmitted the first request signal.

The display unit 12 of the streetlight 10 is configured for displaying to the passengers who are looking for a taxi the identifications and the locations of the currently vacant taxis taken out from the scheduling signal.

Each streetlight 10 further includes a camera unit 17 mounted at an outside thereof. The camera unit 17 takes an image (or more than one image) of the area surrounding the streetlight 10, and the image is then stored in the storage unit 16. The control unit 11 controls the communicating unit 14 to transmit the image taken by the camera unit 17 to the server 20, whereupon the image is stored in the storage unit 21. The control unit 24 integrates and determines traffic information according to the images transmitted by the plurality of streetlights 10. When a passenger at a streetlight 10 wants to inquire about current traffic information at another (remote) location anywhere else in the system 1, the passenger transmits the desired location to be inquired of to the server 20 via the input unit 15. The control unit 24 obtains the image stored in the storage unit 21 which corresponds to the streetlight 10 nearest the desired location, and controls the communicating unit 22 to transmit the obtained image to the streetlight 10 at which the passenger is located. The obtained image is then displayed on the display unit 12 of the streetlight 10.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A streetlight comprising:
a light-emitting unit configured for illuminating a thoroughfare;
a storage unit configured for pre-storing a location of the streetlight;
a communicating unit configured for communicating with a server;
an input unit mounted facing toward an outside of the streetlight, the input unit configured for generating a first request signal in response to a user operation thereon;
a control unit configured for obtaining the location of the streetlight stored in the storage unit in response to the first request signal, generating a second request signal carrying the obtained location, and controlling the communicating unit to transmit the second request signal to the server for the server to schedule one or more taxis which are currently vacant and whose current locations are near the obtained location; and
a display unit configured for displaying the one or more current locations and one or more identifications of the one or more taxis scheduled.

2. The streetlight of claim 1, further comprising a camera unit mounted at an outside of the streetlight, the camera unit configured for taking an image of the area surrounding the streetlight, and the storage unit further configured for storing the image.

3. The streetlight of claim 2, wherein the control unit is further configured for controlling the communicating unit to transmit the image taken by the camera unit to the server for the server to integrate and determine traffic information according to the images.

4. A server for scheduling taxis by communicating with a plurality of streetlights and with a plurality of taxi terminals each employed in a taxi, the server comprising:
a storage unit configured for pre-storing a table recording a plurality of identifications of the taxi terminals, and storing current locations and current states of taxis employing the taxi terminals, wherein the current locations and states are transmitted to the server after every one of predetermined time intervals has elapsed;
a communicating unit configured for communicating with the plurality of streetlights and the plurality of taxi terminals;
a processing unit configured for determining one or more taxi terminals corresponding to taxis which are currently vacant according to the information stored in the table, and further determining according to the information stored in the table one or more taxi terminals of the one or more currently vacant taxis whose one or more current locations are near a location input to the communicating unit from one of the streetlights; and
a control unit configured for generating a scheduling signal carrying the input location and the one or more identifications and locations of the one or more taxis which are near the input location, and controlling the communicating unit to transmit the scheduling signal to the corresponding one or more taxi terminals and the streetlight which input the location.

5. The server for scheduling taxis of claim 4, wherein the current state of each taxi is selected from the group consisting of vacant, engaged and off-duty.

6. The server for scheduling taxis of claim 4, wherein the storage unit is further configured for storing images taken by the plurality of streetlights and transmitted to the server.

7. The server for scheduling taxis of claim 6, wherein the control unit is further configured for integrating and determining traffic information according to the images taken by the plurality of streetlights and transmitted to the server.

8. A system for calling for taxis comprising:
a server;
a plurality of streetlights; and
a plurality of taxi terminals communicating with the server, wherein each of the plurality of taxi terminals is employed in a taxi, and each of the plurality of taxi terminals is configured for transmitting a current location and state to the server after every one of predetermined time intervals has elapsed;
each of the plurality of streetlights comprising:
a display unit;
a light-emitting unit configured for illuminating a thoroughfare;
a first storage unit configured for pre-storing a location of the streetlight;
a first communicating unit configured for communicating with the server;
an input unit mounted facing toward an outside of the streetlight, the input unit configured for generating a first request signal in response to a user operation thereon; and
a first control unit configured for obtaining the location of the streetlight stored in the storage unit in response to the first request signal, generating a second request signal carrying the obtained location, and controlling the communicating unit to transmit the second request signal to the server;
the server comprising:
a second storage unit configured for pre-storing a table recording a plurality of identifications of the taxi terminals, and storing current locations and states of taxis employing the taxi terminals;
a second communicating unit configured for communicating with the plurality of streetlights and the plurality of taxi terminals;
a processing unit configured for determining one or more taxi terminals corresponding to taxis which are currently vacant according to the information stored in the table, and further determining according to the information stored in the table one or more taxi terminals of the one or more currently vacant taxis whose one or more current locations are near the obtained location; and
a second control unit configured for generating a scheduling signal carrying the obtained location and the one or more identifications and locations of the one or more taxis which are near the obtained location, and controlling the second communicating unit to transmit the scheduling signal to the corresponding one or more taxi terminals and the streetlight which transmitted the first request signal;
wherein each of the corresponding one or more taxi terminals shows the location of the streetlight which transmitted the first request signal in response to the scheduling signal; and
the display unit of the streetlight which transmitted the first request signal displays the one or more current locations and the one or more identifications of the one or more taxis scheduled.

9. The system for scheduling taxis of claim 8, wherein each streetlight further comprises a camera unit mounted at an outside of the streetlight, the camera unit configured for taking an image of the area surrounding the streetlight, and the first storage unit further configured for storing the image.

10. The system for scheduling taxis of claim 9, wherein the first control unit controls the first communicating unit to transmit the image taken by the camera unit to the server, and the second control unit integrates and determines traffic information according to the images transmitted to the server from the plurality of streetlights.

11. The system for scheduling taxis of claim 8, wherein the current state of each taxi is selected from the group consisting of vacant, engaged and off-duty.
